(19) United States
(12) Patent Application Publication
(10) Pub. No.: US 2018/0178647 A1
(43) Pub. Date: Jun. 28, 2018

(54) LINEAR MOTION DRIVEN POWER PLANT

(71) Applicant: Cole Newman, Imperial, MO (US)

(72) Inventor: Cole Newman, Imperial, MO (US)

(21) Appl. No.: 15/834,303

(22) Filed: Dec. 7, 2017

Related U.S. Application Data
(60) Provisional application No. 62/439,774, filed on Dec. 28, 2016.

(51) Int. Cl. B60K 17/26; F16D 41/12; F16D 41/069; B60G 13/08; B60K 1/00; B60K 17/02; B60K 17/22

(52) U.S. Cl. CPC B60K 17/26; F16D 41/12; F16D 41/069; B60K 17/22; B60K 1/00; B60K 17/02; B60G 13/08

(57) ABSTRACT

For driving a power plant with linear motion, an arc clutch engages and drives a power plant shaft in response to the arc clutch being rotated in a first angular direction and disengages from the power plant shaft in response to the arc clutch being rotated in a second angular direction that is opposite the first angular direction. The power plant is driven by the rotating power plant shaft. A motivator is physically connected to the arc clutch and transfers a linear motion to the arc clutch.

### CROSS-REFERENCE TO RELATED APPLICATIONS

This application claims priority to U.S. Provisional Patent Application 62/439,774 entitled “LINEAR MOTION DRIVEN POWER PLANT” and filed Dec. 28, 2016 for Cole Newman, which is incorporated herein by reference.

### FIELD

The subject matter disclosed herein relates to linear motion and more particularly relates to a linear motion driven power plant.

### BACKGROUND

### Description of the Related Art

Linear motion is available to harvest in many systems, including automobiles.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1A is a side view drawing illustrating one embodiment of a suspension system with a linear motion driven apparatus;

FIG. 1B is a side view drawing illustrating one alternate embodiment of a suspension system with a linear motion driven apparatus;

FIG. 2A is a perspective drawing illustrating one embodiment of a linear motion driven apparatus;

FIG. 2B is a side view drawing of one embodiment of a ratchet clutch;

FIG. 2C is a side view drawing of one embodiment of a clutch with cover;

FIG. 3A is a perspective drawing illustrating one alternate embodiment of a linear motion driven apparatus;

FIG. 3B is a side view drawing of one embodiment of a roller clutch;

FIG. 4A is a perspective drawing illustrating one alternate embodiment of a linear motion driven apparatus;

FIG. 4B is a side view drawing of one embodiment of a Sprague clutch;

FIG. 4C is a side view drawing of one embodiment of a Sprague;

FIG. 5 is a perspective drawing illustrating one embodiment of a linear motion driven apparatus driven by a hydraulic motivator; and

FIG. 6 is a schematic flow chart diagram illustrating one embodiment of a linear motion conversion method.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure may refer to elements of proceeding figures. Like numbers refer to like elements in all figures, including alternate embodiments of like elements.

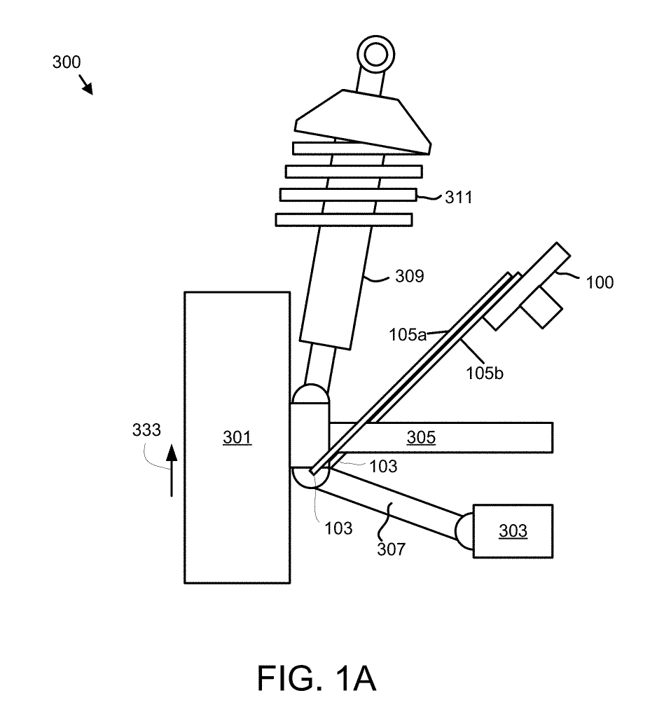

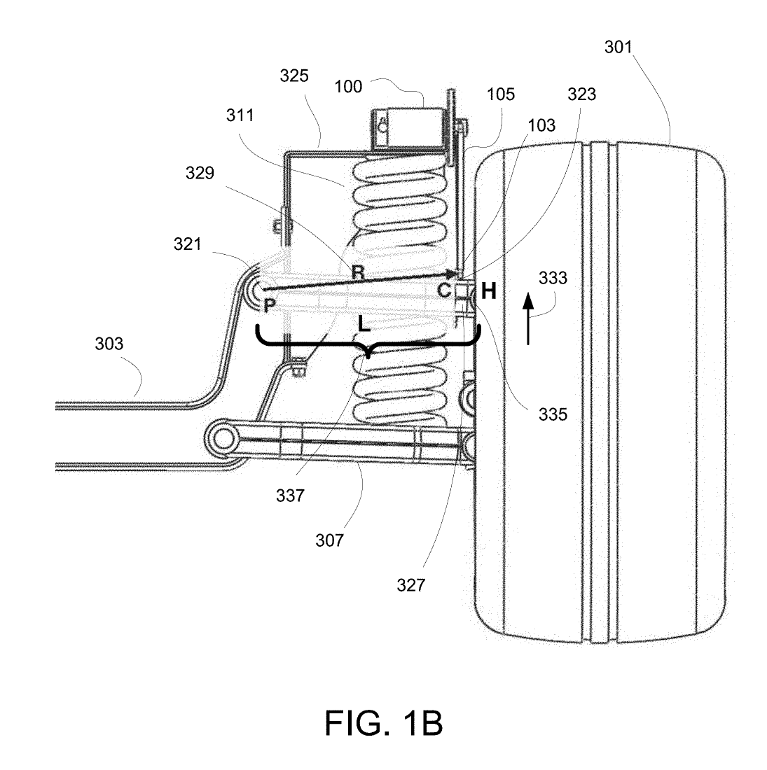

FIG. 1A is a side view drawing illustrating one embodiment of a suspension system 300 with a linear motion driven apparatus 100. A wheel 301 and an axle 305 of an automobile are shown. A lower control arm 307 connects the wheel 301 and the axle 305 to the frame 303. A shock absorber 309 and spring 311 are also connected to the wheel 301 and axle 305 and dampen a linear motion 333 of the wheel 301 relative to the frame 303.

The embodiments described herein convert the linear motion 333 of the wheel 301 into a rotary motion with the linear motion driven apparatus 100. The wheel 301 is connected to the apparatus 100 by motivators 105a-b. In the depicted embodiment, the motivators 105a-b are rod motivators 105a-b. Each rod motivator 105a-b may include a rod distal end 103 connected to the wheel 301 and/or axle 305. The motivators 105a-b transfer the linear motion 333 of the wheel 301 to the apparatus 100 and the apparatus 100 converts the linear motion 333 into a rotary motion as will be described hereafter.

FIG. 1B is a side view drawing illustrating one alternate embodiment of a suspension system 300 with a linear motion driven apparatus 100. In the depicted embodiment, the apparatus 100 is mounted parallel to an axis of the spring 311. In a certain embodiment, the apparatus 100 is mounted along the axis of the spring 311. The apparatus 100 may be mounted on a mounting bracket 325. The motivators 105 may be connected to an upper control arm 327 at a connection point 323.

The upper control arm 327 may be connected to the suspension system 300 at a pivot point P 321. The tire 301 may move with the linear motion D_{H} 333 and a velocity V_{H} at a connection point H 335 about the pivot point P 321. The length L 337 is the distance from pivot point P 321 to connection point H 334. The force of the linear motion 333 is transferred to the motivators 105. The stroke length, velocity, and sensitivity of movement that is transferred to the motivators 105 is a function of the radius R 329 from the pivot point 321 to the connection point 323. Parameters for the apparatus 100 may be selected as a function of the radius 329 and length 337 as will be described hereafter.

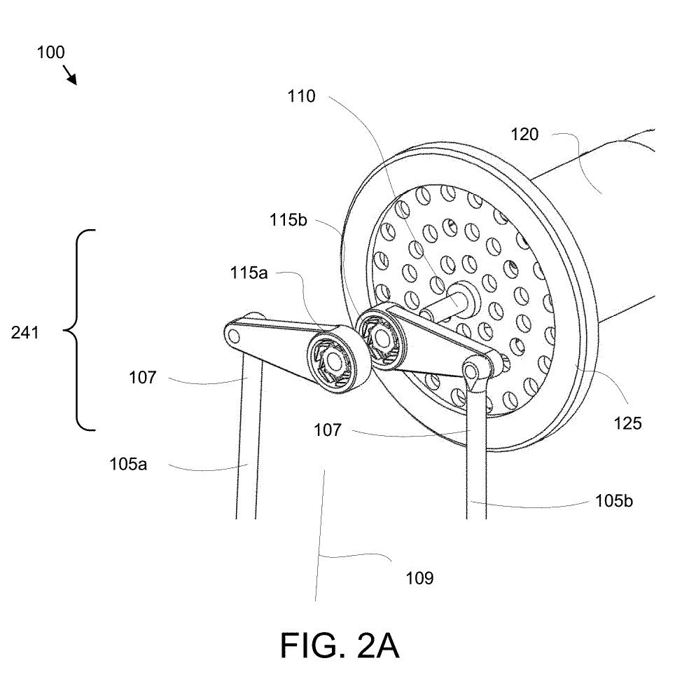

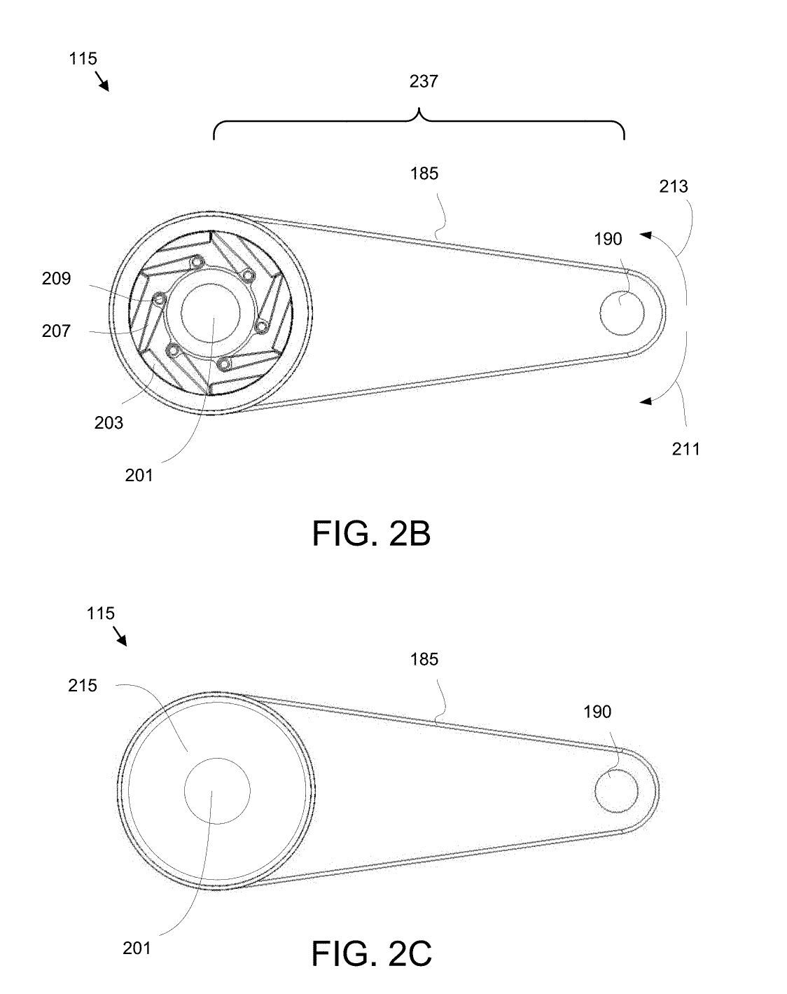

FIG. 2A is a perspective drawing illustrating one embodiment of the linear motion driven apparatus 100 driven by the rod motivators 105. The apparatus 100 may convert a linear motion 333 into a rotary motion. The apparatus 100 includes a power plant 120, a power plant shaft 110, one or more arc clutches 115, and one or more motivators 105. In one embodiment, the apparatus 100 includes a flywheel 125.

In the depicted embodiment, the motivators 105 are rod motivators 105. Each rod motivator 105 may include a rod proximal end 107 connected to an arc clutch 115. The rod motivators 105 move in a substantially linear direction as motivated by the wheel 301 and/or axle 305. As used herein, a substantially linear direction is within 15° of a motivator axis 109. For example, a vehicle hitting a bump may compress the vehicle suspension 300, transferring the linear motion 333 to the second rod motivator 105b.

Each motivator 105 may have a motivator travel range 241. The motivator travel range 241 may represent the extreme positions of the rod proximal end 107 along the motivator axis 109.

The first rod motivator 105a may be physically connected to the first arc clutch 115a and may transfer the linear motion 333 from the vehicle suspension or other source to the first arc clutch 115a. The arc clutches 115 engage and drive the power plant shaft 110 in response to the arc clutches 115 being rotated in specific angular directions by the motivators 105 and disengage from the power plant shaft 110 in response to being rotated in opposite angular directions by the motivators. In the depicted embodiment, the arc clutches 115 are ratchet arc clutches 115. For example, a first arc clutch 115a may engage and drive the power plant shaft 110 in response to the first arc clutch 115a being rotated in a first angular direction by the first rod motivator 105a. In addition, the first arc clutch 115a may disengage from the power plant shaft 110 in response to the first arc clutch 115a being rotated in a second angular direction that is opposite the first angular direction by the first rod motivator 105a.

In addition, the second rod motivator 105b may be physically connected to the second arch clutch 115b and may transfer the linear motion of the vehicle suspension or other source to the second arc clutch 115b. The second arc clutch 115b may engage in drive the power plant shaft 110 in response to the second arc clutch 115b being rotated in the second angular direction. The second arc clutch 115b may further disengage from the power plant shaft 110 in response to the second arc clutch 115b being rotated in the first angular direction.

The power plant 120 may be driven by the power plant shaft 110. In one embodiment, the power plant 120 may be a generator and generates electricity. In an alternative embodiment, the power plant 120 may transfer torque. As a result, the linear motion 333 of the vehicle suspension may be used to turn the power plant shaft 110, motivating the power plant 120.

The flywheel 125 may be physically connected to the power plant shaft 110. In one embodiment, the flywheel 125 moderates the acceleration and deceleration of the power plant shaft 110.

FIG. 2B is a side view drawing of one embodiment of a ratchet arc clutch 115. The ratchet arc clutch 115 is depicted with a cover (not shown) removed. The ratchet arc clutch 115 includes a clutch arm 185 and a clutch connection 190. The clutch arm 185 connects to the motivator 105 at the clutch connection 190. The motivator 105 may move the clutch arm 185 in angular directions including a drive direction 211 and a slip direction 213.

The ratchet arc clutch 115 includes a plurality of pawls 207 that rotate about the clutch hole 201 through which the power plant shaft 110 passes. If the ratchet arc clutch 115 rotates in the drive direction 211, the pawls 207 each engage with one of a plurality of ratchets 203 and the clutch hole 201 is driven by the clutch arm 185. If the ratchet arc clutch 115 rotates in the slip direction 213, the pawls 207 do not engage with the ratchets 203 and the clutch arm 185 rotates about the clutch hole 201 without driving the clutch hole 201.

The clutch arm 185 has a clutch radius 237. The clutch radius 237 may be used to determine parameters for the apparatus 100 as will be described hereafter.

FIG. 2C is a side view drawing of one embodiment of a ratchet arc clutch 115 with cover 215. In the depicted embodiment, the cover 215 is in place over the ratchets 203 and pawls 207.

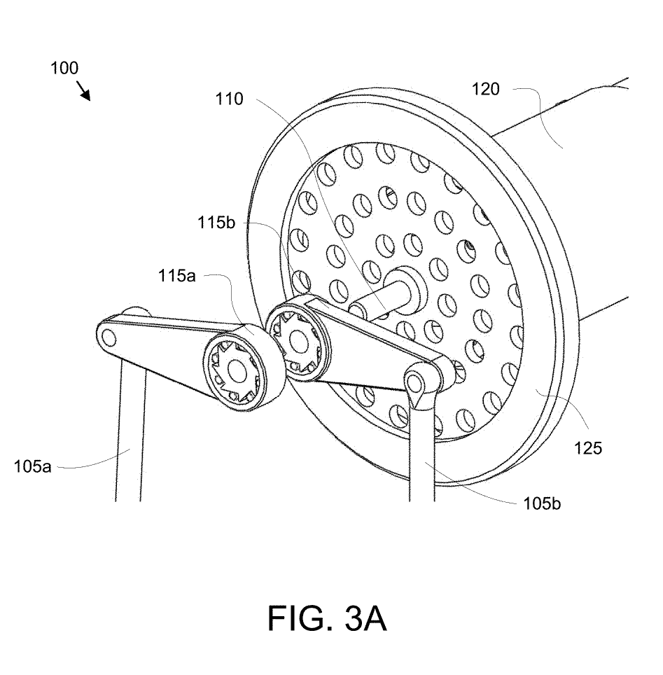

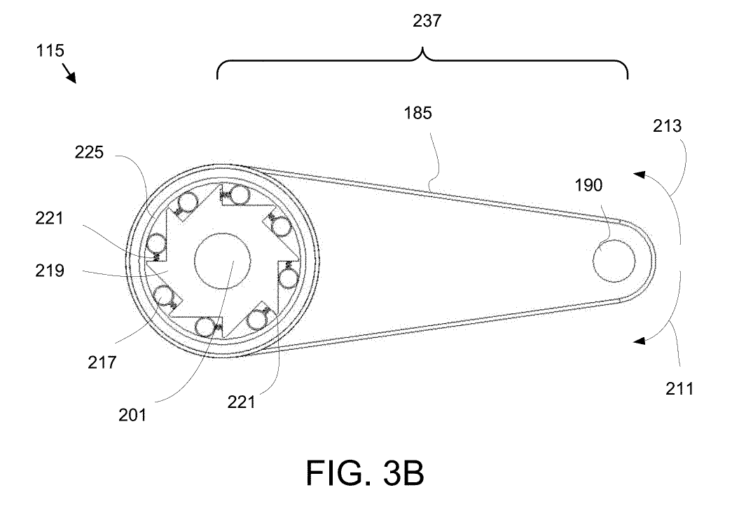

FIG. 3A is a perspective drawing illustrating one alternate embodiment of the linear motion driven apparatus 100. In the depicted embodiment, the apparatus 100 includes a power plant 120, a power plant shaft 110, one or more roller arc clutches 115, one or more motivators 105, and a flywheel 125.

FIG. 3B is a side view drawing of one embodiment of the roller arc clutch 115. In the depicted embodiment, the roller arc clutch 115 is shown without a cover 215. The roller arc clutch includes a plurality of rollers 217 each connected by springs 221 to a hub 219.

If the roller arc clutch 115 rotates in the drive direction 211, the rollers 217 engage with a ring 225 and the clutch hole 201 is driven by the clutch arm 185. If the roller arc clutch 115 rotates in the slip direction 213, the rollers 217 do not engage with the ring 225 and the clutch arm 185 rotates about the clutch hole 201 without driving the clutch hole 201.

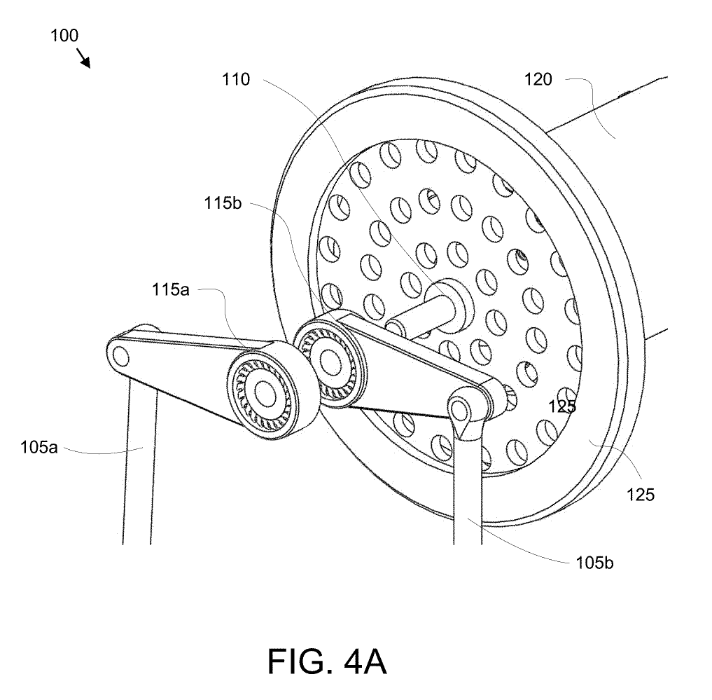

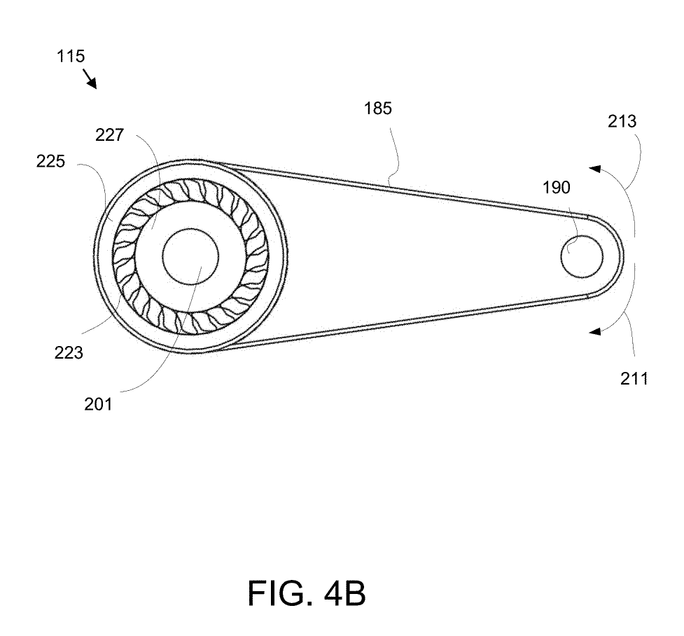

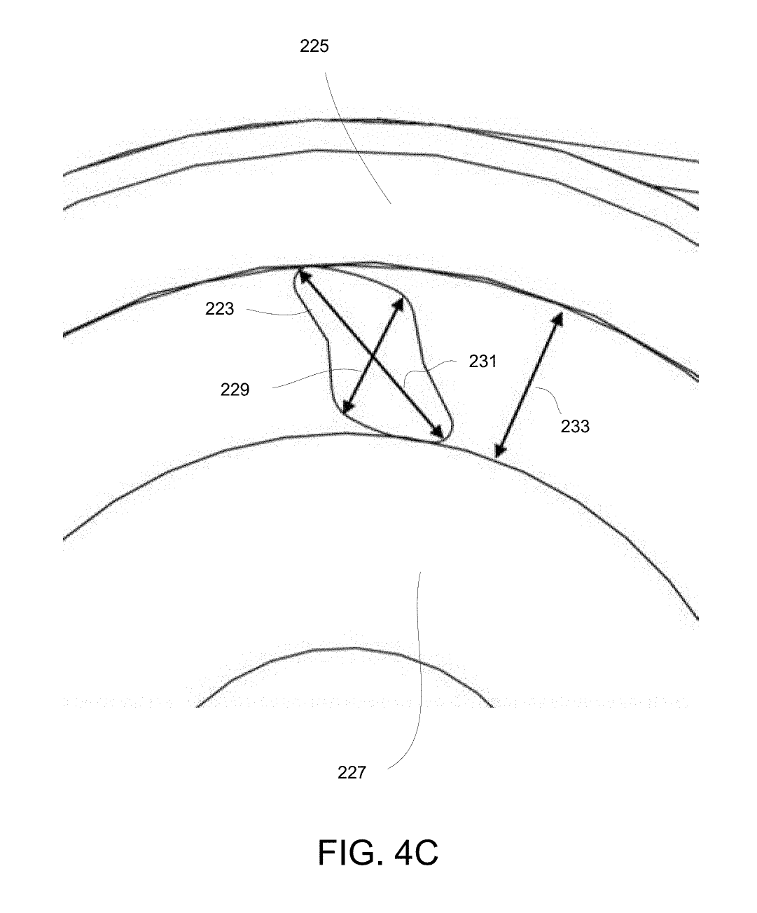

FIG. 4A is a perspective drawing illustrating one alternate embodiment of a linear motion driven apparatus 100. In the depicted embodiment, the apparatus 100 includes a power plant 120, a power plant shaft 110, one or more Sprague arc clutches 115, one or more motivators 105, and a flywheel 125.

FIG. 4B is a side view drawing of one embodiment of a Sprague clutch 115. In the depicted embodiment, the Sprague arc clutch 115 is shown without a cover 215. The Sprague arc clutch includes a plurality of Spraques 223 between an outer ring 225 and an inner ring 227.

If the Sprague arc clutch 115 rotates in the drive direction 211, the Spragues 223 engage with the outer ring 225 and the inner ring 227 and the clutch hole 201 is driven by the clutch arm 185. If the Sprague arc clutch 115 rotates in the slip direction 213, the Spragues 223 do not engage with the ring 225 and the inner ring 227 and the clutch arm 185 rotates about the clutch hole 201 without driving the clutch hole 201.

FIG. 4C is a side view drawing of one embodiment of a Sprague arc clutch 115. A single Sprague 223 is shown disposed between the outer ring 225 and the inner ring 227. The outer ring 225 and the inner ring 227 are separated by a spacing B 233. The Sprague 223 includes a longitudinal axis A 231 and a latitudinal access C 229. In one embodiment, the Sprague 223, the ring 225, and the inner ring 227 satisfy the relationship A>B>C.

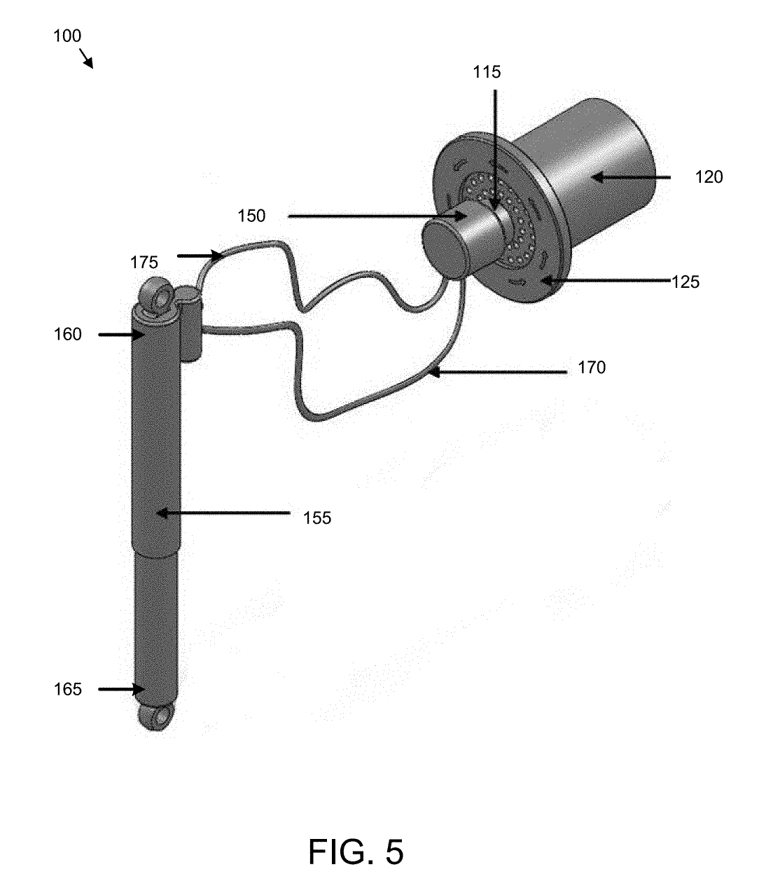

FIG. 5 is a perspective drawing illustrating one embodiment of a linear motion driven apparatus 100 driven by a hydraulic motivator 105. In the depicted embodiment, the motivator 105 is a hydraulic cylinder 155. The hydraulic cylinder 155 includes a cylinder proximal end 160 and a cylinder distal end 165. The cylinder proximal end 160 may be connected to a frame 303. The cylinder distal end 165 may be connected to the suspension system 300. As the hydraulic cylinder 155 is motivated in a first linear motion 333 as being compressed, hydraulic fluid is forced through a transmission hydraulic line 170 that drives the first arc clutch 115a. As the hydraulic cylinder 155 is motivated in the second linear motion such as being decompressed, a return hydraulic line 175 returns the hydraulic fluid from the first arc clutch 115a. As a result, the linear motion motivating the hydraulic cylinder 115 is transformed into a torque that motivates the power plant 120.

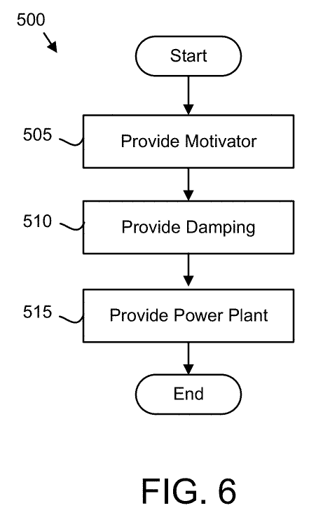

FIG. 6 is a schematic flow chart diagram illustrating one embodiment of a linear motion conversion method 500. The method 500 may provide a power plant 120 that is appropriate for a suspension system 300.

The method 500 starts, and in one embodiment, the method 500 provides 505 a motivator 105 with a motivator travel range 241. In one embodiment, the motivator 105 is provided 505 so as to maximize the motivator travel range T 241. The motivator travel range T 241 may be maximized by maximizing the radius R 329.

In one embodiment, the clutch radius CR 237 is calculated using Equation 1, where D_{H} is the displacement or linear motion 333, R is the radius 329, and L is the length 337, wherein the travel range T 241 is maximized.

CR<=D_{H}(R/2L) Equation 1

The method 500 further provides 510 damping for the suspension system 300 and/or tire 301. Target damping DT for the suspension system 300 may be provided by the apparatus 100, the spring 331, and/or the shock absorber 309. In one embodiment, the damping DP provided by the apparatus 100 is selected using Equation 2, wherein DT is a target damping for the vehicle, R is the radius 329, and K is a nonzero constant.

DP=DT−KR² Equation 2

In one embodiment, the method 500 provides 515 the power plant 120. The power plant 120 and at least one arch clutch 105 may be selected to provide the damping DP for the suspension system 300. The power plant 120 may be selected as a function of the damping D, the motivator travel range T 241, the radius R 329, and a desired damping Q for the suspension system 300.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a power plant shaft;
a first arc clutch that engages and drives the power plant shaft in response to the first arc clutch being rotated in a first angular direction and disengages from the power plant shaft in response to the first arc clutch being rotated in a second angular direction that is opposite the first angular direction;
a power plant that is driven by the rotating power plant shaft; and
a first motivator that is physically connected to the first arc clutch and transfers a linear motion to the first arc clutch.

2. The apparatus of claim 1, wherein the first motivator is a rod with a rod distal end connected to a vehicle suspension and a rod proximal end connected to the first arc clutch.

3. The apparatus of claim 1, wherein the first arc clutch is a ratchet arc clutch.

4. The apparatus of claim 1, wherein the first arc clutch is a roller arc clutch.

5. The apparatus of claim 1, wherein the first arc clutch is a Sprague arc clutch.

6. The apparatus of claim 1, wherein the first motivator is a hydraulic cylinder comprising a cylinder proximal end connected to a vehicle frame, a cylinder distal end connected to a vehicle suspension, a transmission hydraulic line that drives the first arc clutch as the hydraulic cylinder is motivated in a first linear direction, and a return hydraulic line that returns hydraulic fluid from the first arc clutch.

7. The apparatus of claim 1, the apparatus further comprising:
a second arc clutch that engages and drives the power plant shaft in response to the second arc clutch being rotated in the second angular direction and disengages from the power plant shaft in response to the second arc clutch being rotated in the first angular direction; and
a second motivator that is physically connected to the second arc clutch and transfers a motion to the second arc clutch.

8. The apparatus of claim 1, wherein the first arc clutch comprises a clutch arm with a clutch radius CR calculated as CR<=D_{H}(R/2L), where D_{H} is a displacement of a tire and L is a length from a pivot point of the tire to a connection point of the frame, and wherein a travel range is maximized.

9. The apparatus of claim 1, wherein the power plant provides damping for a suspension system, where the damping provided DP calculated as DP=DT−KR², DT is a target damping, and K is a nonzero constant.

10. The apparatus of claim 1, wherein the power plant is an electric generator.

11. A system comprising:
a tire that moves with a displacement;
a power plant shaft;
a first arc clutch that engages and drives the power plant shaft in response to the first arc clutch being rotated in a first angular direction and disengages from the power plant shaft in response to the first arc clutch being rotated in a second angular direction that is opposite the first angular direction;
a power plant that is driven by the rotating power plant shaft; and
a first motivator that is physically connected to the first arc clutch and transfers the displacement of the tire to the first arc clutch.

12. The system of claim 11, wherein the first motivator is a rod with a rod distal end connected to the tire and a rod proximal end connected to the first arc clutch.

13. The system of claim 11, wherein the first arc clutch is a ratchet arc clutch.

14. The system of claim 11, wherein the first arc clutch is a roller arc clutch.

15. The system of claim 11, wherein the first arc clutch is a Sprague arc clutch.

16. The system of claim 11, wherein the first motivator is a hydraulic cylinder comprising a cylinder proximal end connected to a vehicle frame, a cylinder distal end connected to the tire, a transmission hydraulic line that drives the first arc clutch as the hydraulic cylinder is motivated in a first linear direction, and a return hydraulic line that returns hydraulic fluid from the first arc clutch.

17. The system of claim 11, the apparatus further comprising:
a second arc clutch that engages and drives the power plant shaft in response to the second arc clutch being rotated in the second angular direction and disengages from the power plant shaft in response to the second arc clutch being rotated in the first angular direction; and
a second motivator that is physically connected to the second arc clutch and transfers a motion to the second arc clutch.

18. The system of claim 11, wherein the first arc clutch comprises a clutch arm with a clutch radius CR calculated as CR<=D_{H}(R/2L), where D_{H} is the displacement of the tire and L is a length from a pivot point of the tire to a connection point of a frame, and wherein a travel range is maximized.

19. The system of claim 11, wherein the power plant provides damping for the tire, where the damping provided DP calculated as DP=DT−KR², DT is a target damping, R is a radius from a pivot point of the tire to a connection point of a frame, and K is a nonzero constant.

20. The system of claim 11, wherein the power plant is an electric generator.
